(19) United States
(12) Patent Application Publication
(10) Pub. No.: US 2019/0176083 A1
(43) Pub. Date: Jun. 13, 2019

(54) PROCESS AND PLANT FOR OBTAINING PURE HELIUM

(71) Applicant: Linde Aktiengesellschaft, Munchen (DE)

(72) Inventors: Martin BAUER, Munchen (DE); Patrick SCHIFFMANN, Munchen (DE)

(73) Assignee: Linde Aktiengesellschaft, Munchen (DE)

(21) Appl. No.: 16/217,829

(22) Filed: Dec. 12, 2018

(30) Foreign Application Priority Data
Dec. 12, 2017 (EP) 17020570.2

(51) Int. Cl. B01D 53/22; B01D 53/047; C01B 23/00

(52) U.S. Cl. CPC B01D 53/229; B01D 53/226; B01D 53/047; C01B 23/0042; C01B 23/0052; B01D 2256/18; C01B 2210/0053; B01D 2257/108; C01B 2210/001; C01B 2210/0014; C01B 2210/0031; C01B 2210/0051; B01D 2257/504

(57) ABSTRACT

The present invention relates to a process for obtaining pure helium using a first membrane separation stage a second membrane separation stage and a third membrane separation stage. The first membrane separation stage is supplied with a first helium-containing feed mixture, the second membrane separation stage with a second helium-containing feed mixture and the third membrane separation stage with a third helium-containing feed mixture a first permeate and a first retentate are formed in the first membrane separation stage, a second permeate and a second retentate in the second membrane separation stage and a third permeate and a third retentate in the third membrane separation stage. The first feed mixture is formed using at least part of a helium-containing starting mixture. The second feed mixture is formed using at least part of the first permeate. The third feed mixture is formed using at least part of the second permeate. The third permeate is at least partly processed by pressure swing adsorption to obtain pure helium and a residual mixture at least some of the residual mixture is used in the formation of the second or third feed mixture.

The present invention relates to a process and to a plant for obtaining pure helium according to the preamble of the independent claims.

### PRIOR ART

Processes and plants for obtaining helium, especially from natural gas, are described, for example, in the article “Noble Gases” in Ullmann's Encyclopedia of Industrial Chemistry, Online edition, 15 Mar. 2001, DOI: 10.1002/14356007.a10_045.pub2. As well as cryogenic processes, membrane processes are also used to obtain helium from natural gas. It is also possible to use combined processes. For details, reference is made, for example, to section 4.2.1.2, “Crude Helium Extraction by Permeation Processes”, in the article mentioned.

A corresponding membrane process may especially include the use of multiple membrane separation stages, wherein a helium-enriched permeate and a helium-depleted retentate are formed in each membrane separation stage. These membrane separation stages can be connected in different ways.

For example, the article mentioned, in FIG. 23, discloses a process in which a first membrane separation stage is supplied with a helium-containing feed mixture. A permeate from the first membrane separation stage is compressed and supplied to a second membrane separation stage. A permeate from the second membrane separation stage is the product of the process. A retentate from the first membrane separation stage is removed from the process. A retentate from the second membrane separation stage is recycled upstream of the first membrane separation stage and combined with the feed mixture.

US2014/0243574 A1 discloses a three-stage membrane process in which a first membrane separation stage is supplied with a helium-containing feed mixture. A permeate from the first membrane separation stage is compressed and supplied to a second membrane separation stage. A permeate from the second membrane separation stage contains about 30 mole percent of helium. It can be purified further to give a helium product or used in the formation of the feed mixture which is supplied to the first membrane separation stage. For this purpose, for example, it is fed into a tank together with fresh natural gas. A retentate from the second membrane separation stage is supplied to a third membrane separation stage. A permeate from the third membrane separation stage is compressed together with the permeate from the first membrane separation stage and supplied together with it to the second membrane separation stage. Retentates from the first and third membrane separation stages are combined and provided as natural gas product.

In all processes for obtaining helium, it is possible to produce pure helium by using distillation or pressure swing adsorption steps downstream of a cryogenic or membrane-based enrichment. In this way, it is possible to provide high-purity helium products.

Although the present invention is described predominantly with reference to the obtaining of helium from natural gas, it is equally suitable in principle for other fields of use, for example for the recovery of helium from helium-containing gas mixtures that are formed, for example, in the evaporation of helium in cryogenic applications. Corresponding gas mixtures are referred to hereinafter as “starting mixtures”.

The problem addressed by the present invention is that of improving and increasing the efficiency of the obtaining of pure helium using membrane separation stages from corresponding starting mixtures.

### DISCLOSURE OF THE INVENTION

This problem is solved by a process for obtaining pure helium and a corresponding plant having the features of the independent claims. Embodiments of the invention are in each case provided by the dependent claims and the description which follows.

Prior to the elucidation of the advantages of the present invention, some of the terms used in the description of the invention are defined in detail below.

A “permeate” is understood here to mean a gas or gas mixture that has predominantly or exclusively components that are not retained predominantly, if at all, by a membrane used in a membrane separation stage, i.e. that pass through the membrane (essentially or at least preferably) unhindered. Correspondingly, a “retentate” is a gas or gas mixture that has predominantly or exclusively components that are completely or at least predominantly retained by the membrane used in the membrane separation stage.

In the terminology being used here, gas mixtures may be rich or poor in one or more components, where the term “rich” may mean a content of at least 90%, 95%, 99%, 99.9% or 99.99% and the term “poor” a content of not more than 10%, 5%, 1%, 0.1% or 0.01%, on a molar, weight or volume basis. In the terminology being used here, gas mixtures may also be enriched in or depleted of one or more components, where these terms relate to a corresponding content in a different gas mixture that was used to form the gas mixture in question. The gas mixture in question is “enriched” when it includes at least 2 times, 5 times, 10 times, 100 times or 1000 times the content of the component(s) identified, and “depleted” when it includes at most 0.5 times, 0.1 times, 0.01 times or 0.001 times the content of the component(s) identified.

“Pure helium” is understood here to mean especially helium having a purity of at least 99.5 (called “helium 2.5”), 99.9 (helium 2.9), 99.95 (helium 3.5), 99.99 (helium 4.0), 99.995 (helium 4.5), 99.999 (helium 5.0), 99.9995 (helium 5.5), 99.9999 (helium 6.0) or 99.99999 mole percent (helium 6.0).

If it is said here that a gas mixture is “formed” using another gas mixture, this is understood to mean that the gas mixture in question includes at least some of the components that are present in the other gas mixture or formed therefrom. Forming of one gas mixture from another may comprise, for example, branching off part of the gas mixture, feeding in one or more further components or a gas mixture, chemical or physical conversion of at least some components, and also heating, cooling, evaporating, condensing, etc. “Forming” of a gas mixture from another gas mixture may alternatively merely comprise the provision of the other gas mixture or a portion thereof in suitable form, for example in a vessel or a conduit.

The terms “pressure level” and “temperature level” are used in the present invention to characterize pressures and temperatures, these being intended to express the fact that corresponding pressures and temperatures need not be used in a corresponding plant in the form of exact pressure/temperature values. However, such pressures and temperatures typically vary within particular ranges of, for example, ±1%, 5%, 10%, 20% or 25% around an average value. Corresponding pressure levels and temperature levels may lie in disjoint ranges or in overlapping ranges. The same pressure level may also exist, for example, when unavoidable pressure drops occur. The same holds for temperature levels. The pressure levels indicated here in bar are absolute pressures.

The present invention proposes a multistage membrane separation process in which a first, a second and a third membrane separation stage are used, each of which forms a permeate and a retentate. The permeate from the first membrane separation stage is referred to hereinafter as “first” permeate, the permeate from the second membrane separation stage as “second” permeate and the permeate from the third membrane separation stage as “third” permeate. Correspondingly, the retentate from the first membrane separation stage is referred to as “first” retentate, the retentate from the second membrane separation stage as “second” retentate and the retentate from the third membrane separation stage as “third” retentate.

The membrane separation stages are each supplied with gas mixtures. A gas mixture supplied to the first membrane separation stage is referred to here as “first” feed mixture, a gas mixture supplied to the second membrane separation stage as “second” feed mixture and a gas mixture supplied to the third membrane separation stage as “third” feed mixture. In the context of the present invention, the feed mixtures each contain helium in a concentration rising from the first to the third feed mixture. The permeates are each enriched in helium relative to the corresponding feed mixtures; the retentates are each depleted of helium relative to the corresponding feed mixtures.

In the context of the present invention, what is envisaged is that the first feed mixture is formed using at least part of a helium-containing starting mixture, i.e., for example, using natural gas, where further process steps may also be involved in the formation of the first feed mixture, as will be elucidated in more detail hereinafter. Moreover, the present invention envisages that the second feed mixture is formed using at least some of the first permeate, and that the third feed mixture is formed using at least some of the second permeate. In other words, the present invention thus encompasses ever further enrichment of corresponding helium-enriched permeates, leaving respective retentates.

The present invention comprises at least partly processing the third permeate by pressure swing adsorption to obtain the pure helium and a residual mixture, and using at least some of the residual mixture in the formation of the second or third feed mixture. A corresponding residual mixture is also referred to as “tail gas”. It especially comprises the components adsorbed during an adsorption cycle in the pressure swing adsorption, and some of the components unadsorbed at the end of the adsorption cycle in the interstices of the adsorbent. This also includes unadsorbed helium. This essential aspect of the present invention enables particularly efficient operation of the membrane separation stage(s) each additionally charged with the residual mixture, since an increase in the concentration of helium in the respective feed mixtures can be brought about in this way.

In the pressure swing adsorption, which, in the context of the present invention, can be conducted using one or more pressure swing adsorption steps, it is fundamentally not possible to simultaneously form pure helium as product on the one hand, and a residual mixture entirely freed of helium on the other hand. Instead, the residual mixture still contains considerable amounts of helium. The helium concentration in the residual mixture is typically above that in the first and second permeates that are respectively used to form the second and third feed mixtures.

In the multistage membrane processes in question in the present context, it is possible in principle to use what are called “yield stages” and “purification stages”. The aim of the yield stages is to transfer a maximum proportion of helium from the respective feed mixtures into the corresponding permeates and to lose a minimum amount of helium via the retentates. However, it is typically not possible here to avoid transfer of other components present in the feed mixtures into the permeates as well. The permeates therefore have to be processed further to obtain pure helium, namely, for example, in the purification stages and/or, as in the context of the present invention, in a pressure swing adsorption. In a purification stage, by contrast, a maximum helium concentration is to be achieved in the permeates obtained in each case. However, it is typically not possible here to avoid a considerable portion of the helium remaining in the respective retentates. In this case, advantageously, the retentates are recycled, or treated in an additional yield stage in order to utilize this helium.

The present invention advantageously envisages configuring at least two of the three membrane separation stages, namely at least the first and second membrane separation stages, as yield stages. In other words, in the context of the present invention, it is advantageously envisaged that at least 80% of the helium present in the first feed mixture is transferred to the first permeate and at least 80% of the helium present in the second feed mixture to the second permeate. The third membrane separation stage may also be configured as a yield stage, such that at least 80% of the helium present in the third feed mixture is transferred to the third permeate. Independently of one another, it is also possible to transfer greater proportions of the helium present in each of the feed mixtures to each of the permeates, for example at least 90%, 95% or 99%. In this way, the retentates are each poor in or essentially free of helium and therefore do not need to be sent to any further processing in order to recover helium present therein. The “circulated” fluid volumes to be processed in each case are thus reduced by comparison with processes in which purification stages are also implemented in the form of membrane separation stages. In the context of the present invention, the predominant proportion of the gas mixtures being processed passes through the entire process just once. An exception is formed by the residual mixture obtained in the pressure swing adsorption, but that is obtained in a distinctly smaller scope in terms of volume.

Advantageously, the third permeate, which is at least partly processed by the pressure swing adsorption to obtain the pure helium and the residual mixture, has a content of 20 to 80 mole percent, especially of 35 to 65 mole percent, of helium. In this way, the pressure swing adsorption can be conducted particularly efficiently in the context of the present invention.

In order to achieve the particular advantages of the present invention, the residual mixture from the pressure swing adsorption advantageously has a content of 10 to 70 mole percent, especially of 20 to 50 mole percent, of helium.

Advantageously, the process according to the invention is conducted in such a way that the first, second and third feed mixtures are each free of fractions of the first and second retentates. In other words, corresponding retentates are advantageously not recycled upstream of the first, second or third membrane separation stage, but more particularly discharged from the process. They can be provided, for example, as natural gas products that are poor in or free of helium. A corresponding method can especially be effected by the abovementioned configuration, elucidated in detail, of the membrane separation stages as yield stages. If the third membrane separation stage also takes the form of a yield stage, it is also especially possible that the first, second and third feed mixtures are also each free of fractions of the third retentate. This obviates the need for further processing of corresponding retentates, and so a corresponding process can be implemented more easily and less expensively.

In the context of the present invention, the forming of the first feed mixture using at least some of the starting mixture may especially include a heating operation. This is true especially when the feed mixture is formed, for example, by a cryogenic process from the starting mixture or a portion thereof. The starting mixture or a portion separated therefrom is especially heated here to a temperature at which the first membrane separation stage can be operated. A corresponding temperature level may, for example, be 0 to 120° C., especially 30 to 90° C.

The forming of the first feed mixture using at least some of the starting mixture may especially also include a pre-enrichment operation. For example, natural gas used in the context of the present invention can be depleted of hydrocarbons by a condensation step. Particularly methane, hydrogen and the helium to be obtained in the context of the present invention remain in the gas phase in this case. Especially in such a case, one option is a subsequent heating operation prior to the first membrane separation stage. Corresponding pre-enrichment steps may also include adsorption processes instead of or in addition to a condensation process.

More particularly, the forming of the first feed mixture using at least some of the starting mixture, in the context of the present invention, may include a compression operation. By means of this, the starting mixture or a portion thereof can be brought to an inlet pressure at which the first feed mixture is supplied to the first membrane separation stage. Such a pressure level may, for example, be 10 to 120 bar, especially 30 to 100 bar.

The forming of the first feed mixture using at least some of the starting mixture may also include any purification or conditioning of the starting mixture or a portion thereof. More particularly, a removal of water or other trace components may be envisaged here. For purification steps of this kind, it is possible in principle to use known processes or apparatuses. For example, in this way, it is possible to prevent any adverse effect on the membrane separation properties or achieve a longer service life of the membranes.

In the context of the present invention, the forming of the second feed mixture using at least some of the first permeate and/or of the third feed mixture using at least some of the second permeate advantageously includes a compression operation. Such a compression operation brings the first permeate or the second permeate to a pressure at which the second membrane separation stage or the third membrane separation stage can be operated on the inlet side. In the context of the present invention, such a compression can especially be effected using comparatively small compressors since, as mentioned, in the context of the present invention, it is only the permeates from the membrane separation stages and optionally the residual mixture from the pressure swing adsorption that are supplied to the membrane separation stages downstream of each. By contrast with processes in which retentates from corresponding membrane separation stages are also supplied to downstream membrane separation stages, therefore, smaller gas volumes have to be processed.

As already mentioned, the present invention especially comprises designing at least some of the membrane separation stages used as yield stages. As likewise mentioned, for this reason, not just helium but also other components get into the corresponding permeates. Corresponding components may especially also be carbon dioxide when such carbon dioxide is present in the starting mixture and is not removed beforehand. Therefore, the present invention especially envisages, in the forming of the third feed mixture using at least some of the second permeate, a removal of carbon dioxide from the second permeate. A corresponding removal of carbon dioxide can especially be conducted using adsorptive separation steps or purification steps as known in principle from the prior art. A removal of carbon dioxide can prevent carbon dioxide from being transferred to the third permeate or retentate and displaying adverse effects here.

A particularly advantageous configuration of the present invention comprises subjecting the third permeate to the hydrogen depletion before it is at least partly supplied to the pressure swing adsorption. Hydrogen, especially together with helium, gets into the third permeate and ultimately into the pure helium when it is present in the starting mixture and is not removed upstream by suitable means. A hydrogen depletion or a removal of hydrogen can especially be effected catalytically, especially forming water that can be removed in a simple manner by condensation and/or by adsorptive means.

As already elucidated repeatedly, the present invention may especially comprise using natural gas as starting mixture, but it is suitable in principle, as also mentioned, for other starting mixtures as well, for example for gas mixtures that are formed by the evaporation of liquid helium.

The pure helium formed in the context of the present invention especially has a content of at least 99.5 mole percent. With regard to further possible contents, reference is made explicitly to the definition above with regard to “pure helium”.

The present invention also extends to a plant for obtaining pure helium having a first membrane separation stage, a second membrane separation stage and a third membrane separation stage, where means set up to supply the first membrane separation stage with a first helium-containing feed mixture, the second membrane separation stage with a second helium-containing feed mixture and the third membrane separation stage with a third helium-containing feed mixture are provided. The first membrane separation stage is set up to form a first permeate and a first retentate. The second membrane separation stage is set up to form a second permeate and a second retentate. The third membrane separation stage is set up to form a third permeate and a third retentate. According to the invention, means set up to form the first feed mixture using at least part of a helium-containing starting mixture, to form the second feed mixture using at least part of the first permeate, to form the third feed mixture using at least part of the second permeate, to at least partly process the third permeate by pressure swing adsorption to obtain the pure helium and a residual mixture, in order to use at least some of the residual mixture in the formation of the second or third feed mixture, are provided.

With regard to features and advantages of a corresponding plant which advantageously comprises means which enable it to perform a process in the embodiments elucidated hereinabove, reference is hereby explicitly made to the elucidations given hereinabove.

In the process proposed in accordance with the invention and the plants proposed in accordance with the invention in the configurations elucidated above, it is especially possible to use, in the membranes, vitreous polymer membranes having a selectivity for helium over methane of at least 120 or for helium over nitrogen of at least 80.

Embodiments of the invention are hereinbelow more particularly elucidated with reference to the accompanying drawings.

### BRIEF DESCRIPTION OF THE DRAWINGS

FIG. 1 shows a process according to one embodiment of the invention in the form of a schematic process flow diagram.

FIG. 2 shows a process according to one embodiment of the invention in the form of a schematic process flow diagram.

### DETAILED DESCRIPTION OF THE DRAWINGS

In the figures, elements that are mutually corresponding in terms of functionality or construction bear corresponding reference numerals and for the sake of clarity are not repeatedly elucidated. The elucidations which follow relate to processes and corresponding plants in the same way. It will be appreciated that corresponding plants/processes may in practice also comprise optional or obligatory further components/process steps. These are not shown in the figures which follow merely for clarity.

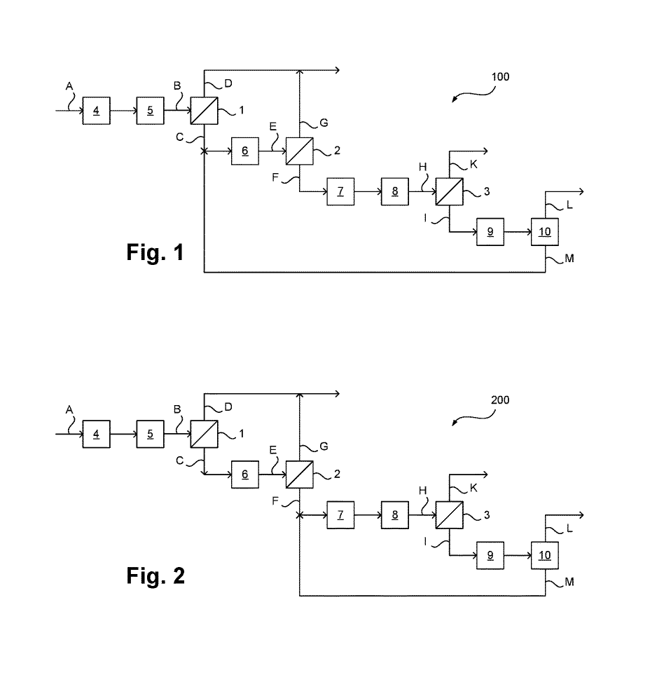

In FIG. 1, a process in one embodiment of the invention is illustrated in the form of a schematic process flow diagram and is collectively labelled 100. In the process 100, a first membrane separation stage 1, a second membrane separation stage 2 and a third membrane separation stage 3 are used.

The process is supplied with a helium-containing starting mixture A. Using at least some of this helium-containing starting mixture A, for example natural gas, by means of any optional processing steps 4 and with a change in temperature 5, a first feed mixture B is formed, which is supplied to the first membrane separation stage 1. As already elucidated above, the first feed mixture B may, however, in principle also be the same as the starting mixture A, meaning that it is supplied to the first membrane separation stage 1 partly or entirely in unchanged form.

In the first membrane separation stage 1, a first permeate C and a first retentate D are formed. Using the first permeate C, with compression 6, a second feed mixture E is formed and supplied to the second membrane separation stage 2. The first retentate D, by contrast, is discharged from the process 100.

In the second membrane separation stage 2, a second permeate F and a second retentate G are formed. Using the second permeate F, with compression 7 and carbon dioxide removal 8, a third feed mixture H is formed and supplied to the third membrane separation stage 3. Like the first retentate D, the second retentate G is also exported from the process 100. The retentates D and G are combined in the example shown.

In the third membrane separation stage 3, a third permeate I and a third retentate K are formed, and the third permeate I is subjected to a hydrogen removal 9 and then supplied to a pressure swing adsorption 10. The third retentate K may likewise be discharged from the process 100 or be recycled in any desired manner. More particularly, the third retentate K can be combined with the first retentate D and/or the second retentate G.

In the pressure swing adsorption 10, pure helium L and a residual mixture M are formed. The pure helium L can be discharged from the process as product. In the embodiment of the present invention shown, the residual mixture M is recycled upstream of the second membrane separation stage 2 or of the compression 6, and is especially combined with the first permeate C.

FIG. 2 shows a process in a further embodiment of the present invention in the form of a schematic process flow diagram collectively labelled 200.

The process 200 illustrated in FIG. 2 differs from the process 100 illustrated in FIG. 1 essentially in that the residual mixture M is supplied not upstream of the second membrane separation stage 2 but upstream of the third membrane separation stage 3 and is supplied to the compression 7 and the carbon dioxide removal 8.

However, a corresponding residual mixture M can also be recycled at both positions illustrated in the process 100 or 200. In this context, partial recycling at both positions is especially possible.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding European application No. 170205702, filed Dec. 12, 2017, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. Process (100, 200) for obtaining pure helium using a first membrane separation stage (1), a second membrane separation stage (2) and a third membrane separation stage (3), where the first membrane separation stage (1) is supplied with a first helium-containing feed mixture, the second membrane separation stage (2) with a second helium-containing feed mixture and the third membrane separation stage (3) with a third helium-containing feed mixture, and where a first permeate and a first retentate are formed in the first membrane separation stage (1), a second permeate and a second retentate in the second membrane separation stage (2) and a third permeate and a third retentate in the third membrane separation stage (3), characterized in that the first feed mixture is formed using at least part of a helium-containing starting mixture, in that the second feed mixture is formed using at least part of the first permeate, in that the third feed mixture is formed using at least part of the second permeate, in that the third permeate is at least partly processed by pressure swing adsorption (10) to obtain the pure helium and a residual mixture, and in that at least some of the residual mixture is used in the formation of the second or third feed mixture.

2. Process (100, 200) according to claim 1, in which at least 80% of the helium present in the first feed mixture is transferred to the first permeate and in which at least 80% of the helium present in the second feed mixture is transferred to the second permeate.

3. Process (100, 200) according to claim 1, in which the third permeate has a content of 20 to 80 mole percent of helium.

4. Process (100, 200) according to claim 1, in which the residual mixture has a content of 10 to 70 mole percent of helium.

5. Process (100, 200) according to claim 1, in which the forming of the first feed mixture using at least some of the starting mixture includes a heating operation.

6. Process (100, 200) according to claim 1, in which the forming of the first feed mixture using at least some of the starting mixture includes a pre-enrichment operation.

7. Process (100, 200) according to claim 1, in which the forming of the second feed mixture using at least some of the first permeate and/or of the third feed mixture using at least some of the second permeate includes a compression operation.

8. Process (100, 200) according to claim 1, in which the forming of the third feed mixture using at least some of the second permeate and/or the forming of the second feed mixture using at least some of the first permeate includes a carbon dioxide removal operation.

9. Process (100, 200) according to claim 1, in which the third permeate is subjected to a depletion of hydrogen before it is at least partly subjected to the pressure swing adsorption.

10. Process (100, 200) according to claim 1, in which the starting mixture used is natural gas.

11. Process (100, 200) according to claim 1, in which the pure helium has a content of at least 99.5 mole percent.

12. Process (100, 200) according to claim 1, in which the first, second and third feed mixtures are each free of fractions of the first and second retentates.

13. Process (100, 200) according to claim 1, in which the forming of the first feed mixture using at least some of the starting mixture includes a compression operation.

14. Plant for obtaining pure helium having a first membrane separation stage (1), a second membrane separation stage (2) and a third membrane separation stage (3), where means set up to supply the first membrane separation stage (1) with a first helium-containing feed mixture, the second membrane separation stage (2) with a second helium-containing feed mixture and the third membrane separation stage (3) with a third helium-containing feed mixture are provided, where the first membrane separation stage (1) is set up to form a first permeate and a first retentate, where the second membrane separation stage (2) is set up to form a second permeate and a second retentate, and where the third membrane separation stage (3) is set up to form a third permeate and a third retentate, characterized by means set up to form the first feed mixture using at least part of a helium-containing starting mixture, to form the second feed mixture using at least part of the first permeate, to form the third feed mixture using at least part of the second permeate, to at least partly process the third permeate by pressure swing adsorption to obtain the pure helium and a residual mixture, and to use at least some of the residual mixture in the formation of the second or third feed mixture.

15. (canceled)

16. Plant for obtaining pure helium by the process according to claim 1, the plant having a first membrane separation stage (1), a second membrane separation stage (2) and a third membrane separation stage (3), where means set up to supply the first membrane separation stage (1) with a first helium-containing feed mixture, the second membrane separation stage (2) with a second helium-containing feed mixture and the third membrane separation stage (3) with a third helium-containing feed mixture are provided, where the first membrane separation stage (1) is set up to form a first permeate and a first retentate, where the second membrane separation stage (2) is set up to form a second permeate and a second retentate, and where the third membrane separation stage (3) is set up to form a third permeate and a third retentate, characterized by means set up to form the first feed mixture using at least part of a helium-containing starting mixture, to form the second feed mixture using at least part of the first permeate, to form the third feed mixture using at least part of the second permeate, to at least partly process the third permeate by pressure swing adsorption to obtain the pure helium and a residual mixture, and to use at least some of the residual mixture in the formation of the second or third feed mixture.
